(19) United States
(12) Patent Application Publication
(10) Pub. No.: US 2013/0315578 A1
(43) Pub. Date: Nov. 28, 2013

(54) METHOD OF CREATING A TIME-LAPSE LENTICULAR PRINT

(71) Applicants: Kemal Arin, Provo, UT (US); Goktan N. Goktas, Lebanon, TN (US)

(72) Inventors: Kemal Arin, Provo, UT (US); Goktan N. Goktas, Lebanon, TN (US)

(21) Appl. No.: 13/678,542

(22) Filed: Nov. 15, 2012

Related U.S. Application Data
(60) Provisional application No. 61/560,253, filed on Nov. 15, 2011.

(51) Int. Cl. G03B 15/08

(52) U.S. Cl. CPC G03B 15/08
USPC 396/661

(57) ABSTRACT

The present invention provides a method for creating lenticular prints, generally for use as postcards, in which an historical photograph is interlaced with a contemporary photograph. In order to provide a more accurate illusion of morphing between photographs, the photographer determines the approximate position and orientation of the original camera lens, the approximate equivalent focal length and f-stop (i.e., lens aperture) of the original lens. He may also attempt to duplicate other parameters of the original photograph, such as the time of day and time of year, as well as other physical conditions such as cloud cover and snowfall. No matter how hard a photographer may try, some historical photographs will be impossible to simulate, as certain conditions may be impossible to replicate. Natural processes or man-made changes, such as new buildings or the destruction of old buildings may either preclude or hamper complete simulation of the original photograph.

### BACKGROUND OF THE INVENTION

1. Field of the Invention

This invention relates generally to lenticular photography and printing and, more particularly, to methods for creating intermorphing time-lapse photographs having a high degree of accuracy with respect to duplication of camera lens placement, lens focal length, lens aperture, and other factors which affect the morphing experience of observers.

2. History of the Prior Art

Lenticular printing is a technology, dating from the early 1940s, in which a lenticular lens (a unified array of adjoining parallel cylindrical lenses, or lenticules) is used to produce images with an illusion of depth, or the ability to change or move as the image is viewed from different angles. Though originally used primarily for the manufacture of novelty items, such as the “wiggle picture” prizes found in Cracker Jack® snack boxes that feature flip and other animation effects such as winking eyes, technological advances in recent years in the design of large-format presses have allowed for the use of oversized lenticular lenses which provide greater ranges of perceived motion and depth. Thus, lenticular prints are being used extensively for advertising graphics that change their message as the viewing angle changes and for marketing tools, which show products in motion or operation. The use of lenticular images has seen a recent surge in popularity, and they are now found on magazine covers, on trading cards, as well as on sports posters and on signs in stores that intended to attract the attention of customers.

Lenticular printing is a multi-step process whereby an interlaced image of at least two pictures or photographs is combined with a lenticular lens. Using the latest precision manufacturing techniques, thirty or more images can be combined. This process can be used to create various frames of animation (for a motion effect), to provide multiple layers having different incremental offsets (for a 3D effect) or, simply, to show a set of alternate images which may appear to transform, or morph, into each other. Once the various images are collected, each image is compressed either horizontally or vertically (depending on the planned orientation of the lens lenticules) into individual frame files, and then combined into a single final file using a process called interlacing. For modern lenticular processing, file compression and interlacing are performed using a digital computer. The process is then completed by printing the interlaced image directly on the back (smooth side) of the lens. Alternatively, the interlaced image can be printed on a substrate (ideally a synthetic paper), which is then laminated to a lenticular panel, or lens. When printing to the backside of the lens, the critical registration of the fine “slices” of interlaced images must be absolutely correct during the lithographic or screen printing process, otherwise “ghosting” and poor imagery will result. Ghosting is defined as the failure of one of the interlaced images to completely disappear after the viewing angle has been changed in order to view the second image. Although lens quality and lighting conditions are the two most important factors in minimizing ghosting, ghosting can also occur when demand for an effect exceeds the limits and technical capabilities of the lenticular system. Nevertheless, the perception of ghosting can be minimized if the interlaced images are precisely registered so that similar details on one image are superimposed over those of the other(s). If the interlaced images are properly registered (i.e., aligned) with the lens spacing, the combined lenticular print will show two or more different images simply by changing the angle from which the print is viewed. If more (30+) images are used, taken in a sequence, one can even show a short video of about one second. Though normally produced in sheet form, by interlacing simple images or different colors throughout the artwork, lenticular images can also be created in roll form with 3D effects or multi-color changes. Alternatively, one can use several images of the same object, taken from slightly different angles, and then create a lenticular print which shows a stereoscopic 3D effect. 3D effects can only be achieved in a side to side (left to right) direction, as the viewer's left eye needs to be seeing from a slightly different angle than the right to achieve the stereoscopic effect. Other effects, like morphs, motion, and zooms work somewhat better (less ghosting or latent effects) as top-to-bottom effects due to both eyes of the viewer having the same viewing angle, but can be achieved in both directions. There are several film processors that will take two or more pictures and create lenticular prints for hobbyists, at a reasonable cost. Affordable equipment and software is even available for making lenticular prints at home or in the office. This is in addition to the many corporate services that provide high volume lenticular printing.

Processes for the preparation of articles with a lenticular surface are well known in the art. The following patent documents are exemplary of such processes.

U.S. Pat. No. 4,414,316, which issued to Conley on Nov. 8, 1983, to Conley, discloses a flexible composite sheet material having a thermoset patterned relief surface of high quality and definition which is particularly useful for producing high quality optical sheet components such as a lenticular screen sheet for producing three-dimensional pictures and photographs. The composite sheet comprises a flexible base film having front and rear surfaces and a layer of a cured thermosetting polymer overlying the front surface of the base film. The cured thermosetting polymer layer has a nonplanar outer surface defining a predetermined desired relief pattern of high quality and durability and of fine definition in the thermosetting polymer layer. See for example Example I therein.

U.S. Pat. No. 5,466,723, which issued to Dotson on Nov. 14, 1995, to Dotson, discloses a radiation curable adhesive composition which comprises from 15 to 85 percent by weight of beta-carboxyethyl acrylate and from 85 to 15 percent by weight of 2-phenoxyethyl acrylate based on the total weight of the composition. The adhesive provides improved adhesion for laminating a lineiform image sheet to a lenticular array sheet.

U.S. Pat. No. 5,473,406 (apparatus) and U.S. Pat. No. 5,532,786 (method) both of which issued to Hassall, et al. on Dec. 5, 1995 and Jul. 2, 1996, respectively, disclose an image sheet (12) coated with a radiation curable adhesive (48) at a coating station and then laminated to a lenticular array sheet (20) at a laminating station (50). A lamination of the image and array sheets is then positioned on an aligning station (56) where the lenticules of the array sheet are aligned with the image lines (16) of the image sheet. The adhesive is set at a curing station (60). U.S. Pat. No. 6,073,854, which issued to Bravenec, et al. on Jun. 13, 2000, discloses a card (10) for use as a telephone authorization card or the like is comprised of a layer of a backing material (20) such as a stiff plastic material which has some pliability. A thin sheet lenticular lens material (12) has a flat surface (14) on which is printed selected interlaced images. On the other side of the lens material is formed a plurality of lenticules (16) through which the images are viewed. The flat side of the lenticular material is secured to one face (22) of the backing in a convenient manner. A cutting tool is used to form an opening (32) in the outer face of the lenticules and a programmed microchip (30) is inserted in the opening and secured in place. On the outer face of the backing material a magnetic strip (40) containing magnetically encoded indicia is secured. The card is usable in a reader (R) which can scan the magnetic strip and read information from the microchip to allow the user to place a telephone call or conduct other transactions.

U.S. Pat. No. 3,264,164, which issued to Jerothe, et al. on Aug. 2, 1966, discloses a color dynamic, three-dimensional flexible film and method of making the film. The film includes a transparent sheet having a lenticulated outer surface and line printed or image opposite surface.

There are many commercial end uses for lenticular images, which can be made from PVC, APET, acrylic, and PETG, as well as other materials. While PETG and APET are the most common, other materials are becoming popular in order to accommodate outdoor use and special forming due to the increasing use of lenticular images on cups and gift cards. Lithographic printing of lenticular images involves the deposition of ink directly onto the flat side of the lenticular lens. For the creation of high-resolution photographic lenticulars, the interlaced image is typically laminated to the lens. Large format (over 2 m) lenticular images have recently been used in bus shelters and movie theaters. These images are printed using an oversized lithographic press. Many advances have been made to the extrusion of lenticular lens and the way it is printed which has led to a decrease in cost and an increase in quality.

The newest lenticular technology is manufacturing lenticular images using flexo, inkjet and screen-printing techniques. The lens material comes in a roll or sheet which is fed through flexo or offset printing systems at high speed, or printed with UV inkjet machines (usually flat-beds that enable a precise registration). This technology allows high volume 3D lenticular production at low cost. Because, at the beginning of the story, this new technique only allowed to create non contiguous lenses, the only effect available was the 3D effect with a repeating pattern (moiré). In 2010, a European R&D team (Popims) found a method for printing contiguous lenses and is licensing this technology to printing companies. Specific inks are already produced under license of their patents by a major inks and varnishes manufacturer.

Dimensionally-accurate time-lapse photography is probably best exemplified by the intermittent taking of photographs of an organism, such as a plant, as it grows—using a single, fixed-position camera, having a lens with a fixed focal length, fixed aperture and fixed focus in the presence of unvarying lighting conditions. Using such a technique, the organism seems to grow at a vastly accelerated rate before our eyes, while the background remains unchanged.

This inventors have an interest in creating lenticular postcards which morph between two time-lapse images, one of which is an historical photograph, and the other a present-day photograph. A simple example of a time-lapse lenticular postcard is one having interlaced images of the same scene—one image taken in the morning, the other taken at sunset. Using the lenticular format, the morning scene morphs into the sunset scene as the linticular postcard is tilted. In order for any morphing illusion to function properly, certain objects visible in the background of the earlier photograph (e.g., recognizable buildings, structural landmarks, mountains, statues, etc.) must also exist in the later photograph so that it is obvious to an observer that the location is the same. In addition, the identical objects in both photos must be accurately superimposed on one another as the observer changes the viewing angle. The extreme difficulty arises from the fact that the location of the camera used to take an historical photograph is almost certainly unknown, as are the focal length and aperture of that camera's lens. Other unknown variables are the time of year and time day the historical photograph was taken.

### SUMMARY OF THE INVENTION

The present invention provides a method for creating lenticular prints, generally for use as postcards, in which an historical photograph is interlaced with a contemporary photograph that was taken using a camera lens in about the same location, pointed in the about same direction, having about the same focal length, and about the same lens aperture as the camera lens used for the historical photograph. A common location and common direction for the two lenses is essential, as flipping or morphing between the two photographs will appear coarse and crude if images of common objects in the two photographs do not coincide. Another parameter that should be nearly identical is the equivalent focal length of the lens. If the equivalent focal length of the lenses do not coincide, the spacing between background and foreground objects will not be the same. For example, if the lens used for the contemporary photograph has a greater equivalent focal length than the lens used to take the historical photograph, background objects in the contemporary photograph will appear to be more closely spaced than those of the historical photograph. Another parameter that, ideally, should be similar is the aperture of both lenses. If the lens aperture used for the historical photograph is smaller than that used for the contemporary photograph, the historical photograph will have greater depth of field. Ideally, the depth of field for both photographs should be the same. Otherwise, the focus of identical objects in the two photographs may be different. As the best morphing is believed to occur when as many differences as possible are eliminated between the historical photograph and the contemporary photograph, even parameters, such as time of day and time of year should be approximated. The season and time of day affects shadow length, and it is important that the lengths of shadows of identical objects in both photographs be approximately the same. Not only does the season affect shadow length, it also can have a dramatic affect on flowers, shrubbery and trees. The presence of snow in only one of the photographs will also detract from the morphing illusion.

No matter how hard a photographer may try, some historical photographs will be impossible to simulate, as certain conditions may be impossible to replicate. For example, buildings erected in the foreground of the historical photograph following its production may prevent a modern-day photographer from achieving anything close to the same scene frame. Likewise, the location from which the historical photograph was taken may not even exist today, or may be inaccessible. A building may be planted on the spot where the historical photograph was taken. Likewise, if the historical photograph was taken from an elevated structure, such as a building, silo, or tower, that structure may have been torn down over the years. In such a case, the cost of duplicating the original scene frame may escalate to the point of impracticality, and require the use of crane, a lift, a temporary tower, a tethered lighter-than-air craft or a helicopter. Once aircraft are brought into the equation, costs may be completely out of control.

Another problem is alteration of the landscape by man or by natural causes (e.g., earthquakes, slides, or floods). The identical present-day scene frame may not look at all like that of the historical photograph—with no recognizable landmarks—no matter how many of the parameters the present-day photographer is able to duplicate. Though the photographer has created an accurate time-lapse photo, he will fail in the creation of an illusion of morphing between photographs.

Even if the photographer has been able to closely duplicate both the location from which the original photograph was taken and the effective focal length of the lens with which the original photograph was taken, some ghosting effects may still be visible. These ghosting effects can be minimized by ensuring that common features in both photographs are precisely aligned. This can be done using Adobe Photoshop® or other similar graphics editing software. Either of the two images can be stretched, patched and/or shifted so that both images are precisely aligned with one another. In addition, the perception of ghost images resulting from features in one image not present in the other can be minimized by decreasing the vibrancy of an image, adding texture to affected areas, augmenting difference in brightness between the light and dark areas of an image (i.e., increasing the contrast of the image), adding a sepia hue to black and white images, and changing the brightness level. Texture is defined as detail of an object or detail within an area of the photograph. It is a maxim that more texture on either photographic image will alleviate ghosting on the other. Clouds can add texture to an expanse of sky. Thus, a new sky with additional clouds can be used to add texture. Another example of added texture is the insertion of period-faithful automobiles in a street scene.

### DETAILED DISCLOSURE OF THE INVENTION

The present invention provides a method for creating lenticular prints, generally for use as postcards, in which an historical photograph is interlaced with a contemporary photograph. The term “historical photograph” is intended to mean a photograph taken in the past by using unknown photographic parameters. Such unknown photographic parameters include location and orientation of the historic camera lens, focal length of the historic camera lens, f-stop setting of the historic camera, and other compositional aspects such as the season of the year and time of day when the historical photograph was taken. In order to provide a more accurate illusion of morphing between photographs, as many parameters as possible that are associated with the historical photograph are duplicated for the contemporary photograph.

The most critical parameters which must be duplicated are the are the position and orientation of the original camera lens. Determination of these parameters requires a certain amount of detective work. In order to determine the position of the original camera lens with a fair degree of accuracy, certain foreground and background objects from the original photograph must still exist. Duplication of either the positional relationship of a point on each of at least two background objects with a point on at least one foreground object, or the positional relationship of a point on each of at least two foreground objects with a point on at least one background object will result in proper positioning of the lens. As the field of view begins essentially at a point (i.e., at the focal point of the camera lens), there are typically far more background objects than foreground objects. Thus, positional relationship of features on multiple background objects with features on one or two foreground objects will be the norm. This can be accomplished through either intuitive trial and error or by creating two lines of sight, which converge at the correct camera lens location. For example, if there is a range of mountains in the background and a range of hills in a more foreground position, then it should be fairly simple to accurately determine the original camera location by establishing at least two converging sight lines on the original photograph, where foreground and background images are similarly aligned. Once the photographer has determined the position of the historical camera lens, he then aims the lens of the camera at the central point of the historical photograph. This is most accurately done using a single lens reflex camera, where the photographer actually frames the new photograph by looking through the lens.

It should be understood that it may be impossible to duplicate the camera lens position for some historical photographs. For example, buildings erected in the foreground of the historical photograph following its production may prevent a modern-day photographer from achieving anything close to the same scene frame. Likewise, the location from which the historical photograph was taken may not even exist today, or may be inaccessible. A building may be planted on the spot where the historical photograph was taken. Likewise, the historical photograph may have been taken from an elevated structure, such as a building, silo, or tower, which have been torn down over the intervening years. In such a case, duplication of the original scene frame may require the use of crane, a lift, a temporary tower, a tethered lighter-than-air craft or a helicopter. Once aircraft are brought into the equation, costs may escalate to impractically high levels.

The next most critical parameter that must be duplicated is the equivalent focal length of the camera lens used in the taking of the historical photograph. If the equivalent focal length of the lenses do not coincide, the perspectives of the two photographs will not be the same, and the spacing between background and foreground objects will not be the same. For example, if the lens used for the contemporary photograph has a greater equivalent focal length than the lens used to take the historical photograph, background objects in the contemporary photograph will appear to be more closely spaced than those of the historical photograph, and the field of view will be reduced. On the other hand, if the lens used for the contemporary photograph has a shorter equivalent focal length than the lens used to take the historical photograph, background objects in the contemporary photograph will appear to be more distantly spaced than those of the historical photograph, and the field of view will be expanded. Selection of a lens having the same equivalent focal length is most easily accomplished using an adjustable, variable-focal-length lens. Once the location of the original camera lens has been determined, the original scene frame can be readily duplicated by selecting appropriate equivalent focal length and adjusting the orientation (i.e., pointing direction) of that lens, to achieve the correct scene frame of the historical photograph.

Another parameter that should be duplicated is the f-stop, or lens aperture. This setting determines the depth of field of the photograph. Using a very small lens aperture, both background and foreground objects will be in focus. With a large lens aperture, the photographer generally will adjust the focus of the lens for the objects of interest.

Other parameters of the historical photograph that the photographer may desire to duplicate are the time of day and time of year the photograph was taken, as well as other physical conditions such as cloud cover and snowfall. If the historical photograph was taken under cloud cover, it may be much more difficult to determine the time of day and time of year of the photograph, as the only clues to the time of day may well be the length of the shadows. As the best morphing is believed to occur when as many differences as possible are eliminated between the historical photograph and the contemporary photograph, even parameters, such as time of day and time of year should be approximated. The season and time of day affects shadow length, and it is important that the lengths of shadows of identical objects in both photographs be approximately the same. Not only does the season affect shadow length, it also can have a dramatic affect on flowers, shrubbery and trees. The presence of snow in only one of the photographs will also detract from the morphing illusion.

If at least position, orientation and equivalent focal length of the historical camera lens are duplicated, the illusion of morphing will be enhanced when flipping between the historical photograph and the contemporary photograph. Likewise, if these parameters are not duplicated, there will be little illusion of morphing and the flipping between photographs will appear amateurish, coarse and crude.

Even if the photographer has been able to closely duplicate both the location from which the original photograph was taken and the effective focal length of the lens with which the original photograph was taken, some ghosting effects may still be visible. These ghosting effects can be minimized by ensuring that still existing features in the new photograph precisely align with the same features visible in the original photograph. This can be done using Adobe Photoshop® or other similar graphics editing software. Using the editing software, either of the two images can be stretched, patched and/or shifted so that both images are as precisely aligned with one another as possible. In addition, the perception of ghost images resulting from features in one image not present in the other can be minimized by decreasing the vibrancy of the ghosting image, adding texture to affected areas, augmenting difference in brightness between the light and dark areas of the ghosted image (i.e., increasing the contrast of the image), adding a sepia hue to black and white images to reduce their vibrancy, and reducing the brightness level of the ghosting image. Texture is defined as detail of an object or detail within an area of the photograph. It is a maxim that more texture on either photographic image will alleviate ghosting on the other. Clouds can add texture to an expanse of sky. Thus, a new sky with additional clouds can be used to add texture. Another example of added texture is the insertion of period-faithful automobiles in a street scene.

Although only several embodiments of the method have been disclosed herein, it will be obvious to those having ordinary skill in the art that changes and modifications may be made thereto without departing from the scope and spirit of the invention as hereinafter claimed.

What is claimed is:

1. A method of creating a lenticular prints, generally for use as postcards, in which an historical photograph is interlaced with a contemporary photograph to provide a relatively accurate illusion of morphing between photographs, said method comprising the steps of:
accurately determining and duplicating a location and an orientation of an original camera lens with which the historical photograph was taken; and
accurately determining and duplicating an equivalent focal length of the camera lens with which the historical photograph was taken; and
taking the contemporary photograph with a camera positioned and set to duplicate photographic parameters of the historical photograph.

2. The method of creating lenticular prints of claim 1, wherein location of the original camera lens is determined by aligning still-extant background and foreground features of the historical photograph.

3. The method of creating lenticular prints of claim 2, wherein at least two converging sight lines from the historical photograph are established for a location of a camera lens that will be used to take the contemporary photograph, said converging sight lines having still-extant objects of the historical photograph similarly aligned.

4. The method of creating lenticular prints of claim 1, wherein orientation of a lens used to take the contemporary photograph is established by aligning a center of a new image, as seen through the lens of the camera that will be employed to take the contemporary photograph, with a point that corresponds to a center of the historical photograph.

5. The method of creating lenticular prints of claim 4, wherein orientation of a lens used to take the contemporary photograph is established with a single lens reflex camera.

6. The method of creating lenticular prints of claim 1, wherein accurately determining and duplicating an equivalent focal length of the camera lens with which the historical photograph was taken is accomplished using an adjustable, variable-focal-length lens by selecting a focal length and adjusting orientation of the in order to achieve the correct scene frame of the historical photograph.

7. The method of creating lenticular prints of claim 1, which further comprises the step of closely approximating a lens aperture used to take the historical photograph.

8. The method of creating lenticular prints of claim 1, which further comprises the step of closely duplicating a time of day that the historical photograph was taken.

9. The method of creating lenticular prints of claim 1, which further comprises the step of closely duplicating a time of year that the historical photograph was taken.

10. The method of creating lenticular prints of claim 1, which further comprises the step of closely duplicating other physical conditions of the historical photograph, including cloud cover and snowfall.

11. A method of creating a lenticular prints, generally for use as postcards, in which an historical photograph is interlaced with a contemporary photograph to provide a relatively accurate illusion of morphing between photographs, said method comprising the steps of:
accurately determining and duplicating a location and an orientation of an original camera lens with which the historical photograph was taken; and
accurately determining and duplicating an equivalent focal length of the camera lens with which the historical photograph was taken;
taking the contemporary photograph with a camera positioned and set to duplicate photographic parameters of the historical photograph;
generating a compressed image of each photograph;
generating an interlaced image of both photographs; and
affixing a copy of the interlaced image to a rear surface of a lenticular panel, with each interlaced portion aligned with a lenticle of said lenticular panel.

12. The method of creating lenticular prints of claim 11, wherein location of the original camera lens is determined by aligning still-extant background and foreground features of the historical photograph.

13. The method of creating lenticular prints of claim 12, wherein at least two converging sight lines from the historical photograph are established for a location of a camera lens that will be used to take the contemporary photograph, said converging sight lines having still-extant objects of the historical photograph similarly aligned.

14. The method of creating lenticular prints of claim 11, wherein orientation of a lens used to take the contemporary photograph is established by aligning a center of a new image, as seen through the lens of the camera that will be employed to take the contemporary photograph, with a point that corresponds to a center of the historical photograph.

15. The method of creating lenticular prints of claim 14, wherein orientation of a lens used to take the contemporary photograph is established with a single lens reflex camera.

16. The method of creating lenticular prints of claim 11, wherein accurately determining and duplicating an equivalent focal length of the camera lens with which the historical photograph was taken is accomplished using an adjustable, variable-focal-length lens by selecting a focal length and adjusting orientation of the in order to achieve the correct scene frame of the historical photograph.

17. The method of creating lenticular prints of claim 11, which further comprises the step of closely approximating a lens aperture used to take the historical photograph.

18. The method of creating lenticular prints of claim 11, which further comprises the step of closely duplicating a time of day that the historical photograph was taken.

19. The method of creating lenticular prints of claim 11, which further comprises the step of closely duplicating a time of year that the historical photograph was taken.

20. The method of creating lenticular prints of claim 11, which further comprises the step of closely duplicating other physical conditions of the historical photograph, including cloud cover and snowfall.
